(19) United States
(12) Patent Application Publication
(10) Pub. No.: US 2012/0089873 A1
(43) Pub. Date: Apr. 12, 2012

(54) SYSTEMS AND METHODS FOR AUTOMATED SYSTEMATIC CONCURRENCY TESTING

(75) Inventors: Chao Wang, Plainsboro, NJ (US); Aarti Gupta, Princeton, NJ (US)

(73) Assignee: NEC Laboratories America, Inc., Princeton, NJ (US)

(21) Appl. No.: 13/081,684

(22) Filed: Apr. 7, 2011

Related U.S. Application Data
(60) Provisional application No. 61/374,347, filed on Aug. 17, 2010.

(51) Int. Cl. G06F 11/36

(52) U.S. Cl. 714/33; 714/E11.207

(57) ABSTRACT

Systems and method provide a coverage-guided systematic testing framework by dynamically learning HaPSet ordering constraints over shared object accesses; and applying the learned HaPSet ordering constraints to select high-risk interleavings for future test execution.

The present application claims priority to Provisional Application Ser. No. 61/374,347 filed Aug. 17, 2010, the content of which is incorporated by reference.

### BACKGROUND

The present application relates to systematic concurrency testing.

Real-world concurrent programs are notoriously difficult to test because they often have an astronomically large number of thread interleavings. Furthermore, many concurrency related bugs arise only in rare situations, making it difficult for programmers to anticipate, and for testers to trigger, these error-manifesting thread interleavings. In reality, the common practice of load or stress testing is not effective, since the outcome is highly dependent on the underlying operating system which controls the thread scheduling. Merely running the same test again and again does not guarantee that the erroneous interleaving would eventually show up. Typically, in each testing environment, the same interleavings, sometimes with minor variations, tend to be exercised since the scheduler performs context switches at roughly the same program locations.

Systematic concurrency testing techniques offer a more promising solution to bug detection than standard load or stress testing. These techniques typically use a stateless model checking framework to systematically explore all possible thread interleavings with respect to a given test input. The model checking is stateless in that it directly searches over the space of feasible thread schedules, and in doing so, avoids storing the concrete program states (characterized as combinations of values of the program variables); this is in sharp contrast to classic software model checkers, which search over the concrete state space—a well known cause of memory blowup.

In systematic concurrency testing, the model checker is often implemented by using a specialized scheduler process to monitor, as well as control, the execution order of statements of the program under test. A program state s is represented implicitly by the sequence of events that leads the program from the initial state to s. This is based on the assumption that, in a program where interleaving is the only source of nondeterminism, executing the same event sequence always leads to the same state. The state space exploration is conducted implicitly by running the program in its real execution environment again and again, but each time under a different thread schedule. Therefore, systematic concurrency testing can handle programs written in full-fledged programming languages such as C/C++ and Java.

Although systematic concurrency testing has advantages over the common practice of load or stress testing (where we are at the mercy of the OS/thread library in triggering the right interleaving), it is based on a rather brute-force exhaustive search. Although it has been shown to be very effective in unit level testing, because of the often large number of interleavings, such brute-force exhaustive search is practically infeasible for realistic applications at a larger scale. More specifically, its exhaustive search tends to cover all possible interleavings (w.r.t. a given test input) in a pre-determined order, without favoring one interleaving over another or considering the characteristics of the programs or properties to be tested.

Although there exist techniques to reduce the cost of exhaustive search in stateless model checking, such as dynamic partial order reduction and preemptive context bounding, they are not effective for large programs. For example, DPOR groups interleavings into equivalence classes and tests one representative from each equivalence class. It is a sound reduction in that it will not miss any bug. However, in practice many equivalence classes themselves are redundant since they correspond to essentially the same concurrency scenarios. Therefore exhaustively testing them not only is expensive, but also rarely pays off.

### SUMMARY

Systems and methods provide a coverage-guided systematic testing framework by dynamically learning ordering constraints over shared object accesses; and applying the learned ordering constraints to select high-risk interleavings for test execution.

Advantages of the preferred embodiment may include one or more of the following. The system provides a coverage-guided systematic testing framework, where dynamically learned ordering constraints over shared object accesses are used to select only high-risk interleavings for test execution. An interleaving is of high-risk if it has not been covered by the ordering constraints, meaning that it has concurrency scenarios that have not been tested. The method consists of two components. First, the system utilizes dynamic information collected from good test runs to learn ordering constraints over the memory-accessing and synchronization statements. These ordering constraints are treated as likely invariants since they are respected by all the tested runs. Second, during the process of systematic testing, the system uses the learned ordering constraints to guide the selection of interleavings for future test execution. By focusing on only the high-risk interleavings rather than enumerating all possible interleavings, the method can increase the coverage of important concurrency scenarios with a reasonable cost and detect most of the concurrency bugs in practice. The system can be used to capture these ordering constraints and use them as a metric to cover important concurrency scenarios. This selective search strategy, in comparison to exhaustively testing all possible interleavings, can significantly increase the coverage of important concurrency scenarios with a reasonable cost, while maintaining the capability of detecting subtle bugs manifested only by rare interleavings.

### BRIEF DESCRIPTION OF THE DRAWINGS

FIG. 1 shows an exemplary computer system with software that needs testing to be bug-free.

FIG. 2 shows the systematic concurrency tester 3 in more details.

FIGS. 3A-3B show exemplary code fragments under test.

### DETAILED DESCRIPTION

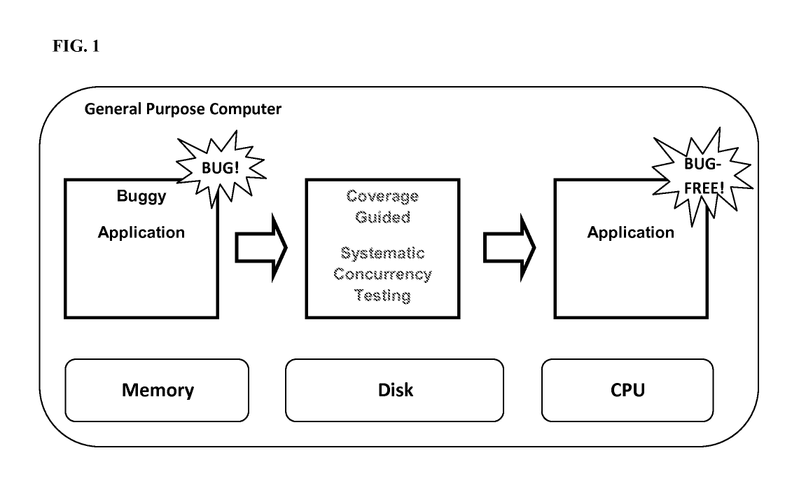

FIG. 1 shows an exemplary computer system with software that needs testing to be bug-free. In FIG. 1, buggy software 1 that includes one or more bugs 2 is process by a systematic concurrency tester 3. The result is application software 4 that is bug free. The system includes memory 6, disk 7 and processor 8. FIG. 1 thus is a generic simple architecture for generating bug-free software and that the verifier techniques could be applied to a computer system whose functions or modules are spread across networks.

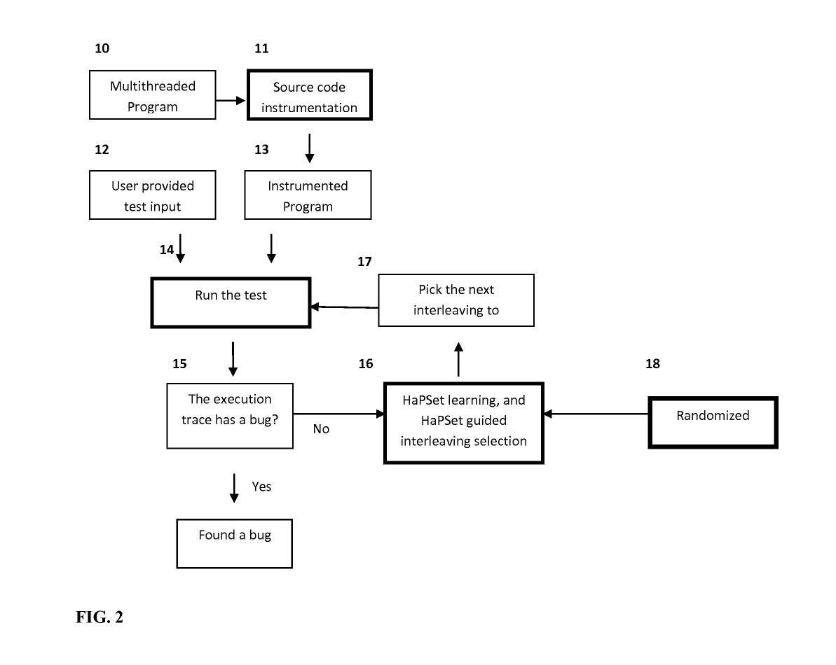

FIG. 2 shows the systematic concurrency tester 3 in more details. A multi-threaded program 10 is provided to a source code instrumentation module 11 to generate an instrumented program 13. User test input 12 and the instrumented program 13 are provided to a tester 14 to run the test. A bug detector 15 determines whether the execution trace has a bug in the application software or not. If so, the bug detector 15 asserts that it found a bug. If not, the trace is provided to a History-aware Predecessor-Set (HaPSet) module 16, which also receives randomized training runs 18. The output from the HaPset module 16 is used by module 17 to pick the next interleaving thread to execute, and the output of module 17 is provided to the tester 14 to continue testing.

The system provides a coverage-guided selective search, where the system continuously learns the ordering constraints over shared object accesses in the hope of capturing the already tested concurrency scenarios. The learned information is used in module 16 to guide the selection of interleavings to cover the untested scenarios. Since in practice, programmers often make, but sometimes fail to enforce, implicit assumptions regarding concurrency control, e.g. certain blocks are intended to be mutually exclusive, certain blocks are intended to be atomic, and certain operations are intended to be executed in a specific order. Concurrency related program failures are often the result of such implicit assumptions being broken, e.g. data races, atomicity violations, order violations, etc. The system infers such assumptions dynamically from the already tested interleavings, and uses them to identify high-risk interleavings, i.e. interleavings that can break some of the learned assumptions.

Although the programmer's intent may come from many sources, e.g. formal design documents and source code annotation, they are often difficult to get in practice. For example, asking programmers to annotate code or write documents in a certain manner is often perceived as too much of a burden. The more viable approach seems to be to infer them automatically. Fortunately, the very fact that stress tests are less effective in triggering bug-manifesting interleavings also implies that it is viable to dynamically learn the ordering constraints. The reason is that, if no program failure occurs during stress tests, one can assume that the tested interleavings are good—they satisfy the programmer's implicit assumptions. In addition, if the program source code is available, the assumptions may also be mined from the code.

The coverage-guided selective search framework uses the History-aware Predecessor-Set (HaPSet) metric to capture the ordering constraints over the frequently occurring (and non-erroneous) interleavings. HaPSets can capture common characteristics of a relatively large set of interleavings. During systematic testing, HaPSets data is used as guidance to reduce the testing cost. Assuming that it is not practical to cover all possible interleavings, the system executes only those interleavings that are not yet covered by HaPSets. During systematic testing, the system also updates the HaPSets by continuously learning from the good interleavings generated in this process, until there are no more interleavings to explore or the desired bug coverage is achieved.

By using HaPSets as guidance in systematic concurrency testing, the system can significantly reduce the testing cost, while still maintaining the capability of detecting most of the concurrency bugs in practice. More specifically, the new selective search algorithm found all the bugs, and at the same time was often orders-of-magnitude faster than exhaustive search.

The system of FIG. 1 is effective in testing concurrent programs with a finite number of threads as a state transition system. Threads may access local variables in their own stacks, as well as global variables in a shared heap. Program statements that read and/or write global variables are called (shared) memory-accessing statements. Program statements that access synchronization primitives are called synchronization statements. Program statements that read and/or write only local variables are called local statements.

For ease of presentation the assumption is that there is only one statement per source code line. Let Stmt be the set of all statements in the program. Then each st∈Stmt corresponds to a unique pair of source code file name and line number. A statement st may be executed multiple times, e.g., when it is inside a loop or a subroutine, or when st is executed in more than one thread. Each execution instance of st is called an event. Let e be an event and let stmt(e) denote the statement generating e. An event is represented as a tuple (tid,type,var), where tid is the thread index, type is the event type, and var is a shared variable or synchronization object. An event may be one of the following forms.
1. (tid,read,var) is a read from shared variable var;
2. (tid,write,var) is a write to shared variable var;
3. (tid,fork,var) creates the child thread var;
4. (tid,join,var) joins back the child thread var;
5. (tid,lock,var) acquires the lock variable var;
6. (tid,unlock,var) releases the lock variable var;
7. (tid,wait,var) waits on condition variable var;
8. (tid,notify,var) wakes up an event waiting on var;
9. (tid,notifyall,var) wakes up all events waiting on var.

In addition, the generic event (tid, access, var) is used to capture all other shared resource accesses that cannot be classified as any of the above types, e.g. accesses to a socket. This embodiment does not monitor thread-local statements.

Next, the state space is discussed. S denotes the set of program states. A transition is an element of the set

$$S {->}^{e} S ,$$

which advances the program from one state to a successor state by executing an event e. An event is enabled in state s if it is allowed to execute according to the program semantics, and

$$s {->}^{e} {s}^{′}$$

denotes that event e is enabled in s, and state s′ is the next state. Two events e₁,e₂ may be co-enabled if there exists a state s in which both of them are enabled. For programs using PThreads (or Java threads), a thread may be disabled due to three reasons: (i) executing lock(var) when var is held by another thread; (ii) executing wait(var) when var has not been notified by another thread; (iii) executing join(var) when thread var has not terminated.

An execution ρ (interleaving) is a sequence s₀, . . . , sₙ of states such that for all 1≦i≦n, there exists a transition

$${s}_{i - 1} {->}^{{e}_{i}} {s}_{i} .$$

During systematic concurrency testing, ρ is stored in a search stack S. s∈S is referred to as an abstract state, because unlike a concrete program state, s does not store the actual valuation of all program variables. (However, s contains concrete memory addresses in order to identify events accessing shared memory locations.) Instead, each s is implicitly represented by the sequence of executed events leading the program from the initial state s₀ to s. This is based on the assumption that executing the same event sequence leads to the same state.

Two concurrent transitions are (conflict) independent if and only if the two events can neither disable nor enable each other, and swapping their order of execution does not change the combined effect. For example, two events are (conflict) dependent if they access the same the object and at least one is a write (modification); and a lock acquire is (conflict) dependent with another lock acquire over the same lock variable. Two interleavings are considered as equivalent iff they can be transformed into each other by repeatedly swapping the adjacent and (conflict) independent transitions.

An execution ρ=s₀ . . . sₙ defines a total order over the set of memory-accessing and synchronization events. The predecessor set (PSet), a prior art known in this field, was designed to efficiently capture the event ordering constraints common to a potentially large set of executions. In one embodiment, PSet is extended to define a new coverage metric called HaPSet. Given a set {ρ₁, . . . , ρₙ} of interleavings and a shared memory-accessing or synchronization statement st∈Stmt. The History-aware Predecessor Set, or HaPSet[st], is a set {st₁, . . . , stₖ} of statements such that, for all i:1≦i≦k, an event e produced by st is immediately dependent upon an event eₜ produced by stᵢ in some interleaving ρⱼ where 1≦j≦n. The metric includes both syntactic and semantic elements. Data conflicts are at the heart of most concurrency errors (data races, atomicity violations, etc.)—these are tracked to make this metric relevant for the purpose of finding bugs. However, a generalization is achieved by associating it syntactically with statements, rather than with events. The thread index is again designed to distinguish between two threads for catching bugs, but abstracts over specific thread ids, thereby ensuring that it is scalable over many threads. Finally, by including a bounded functional context, we provide some measure of context-sensitivity—this is especially useful for object-oriented programs.

There are two main differences between HaPSets and PSets. First, HaPSets consider both synchronization statements (e.g. lock acquires) as well as memory-accessing statements. Second, for each st∈Stmt, in addition to the fields file and line, HaPSets includes thr and ctx, where thr is the thread that executes st and ctx is the call stack at the time st is executed. The reason is as follows: With (file,line), there remains some degree of ambiguity regarding the statement which produces an event at run time. For example, the same statement may be executed in multiple function/method call contexts, or from multiple threads. In many cases, especially in object-oriented programs, such information is useful and should be included in order to capture any meaningful ordering constraint.

Since at run time, both the number of threads and the number of distinct calling contexts can be large, to avoid memory blowup, ctx only stores the most recent k (some small number—5 in trials) entries in the call stack, and thr only takes two values: 0 means it is the local thread, and 1 means it is the remote thread. If e and e′ be two events in an interleaving such that stmt(e)=st and stmt(e′)=st′, then st.thr=0 and st′.thr=1 when tid(e)<tid(e′), and st.thr=1 and st′.thr=0 when tid(e)>tid(e′). One embodiment ignores tid(e)=tid(e′), since it never triggers the HaPSet update. Formally, statement st is now defined as a tuple (file,line,thr,ctx), where file is the file name, line is the line number, thr ∈{0,1} is the thread, and ctx is the truncated calling context.

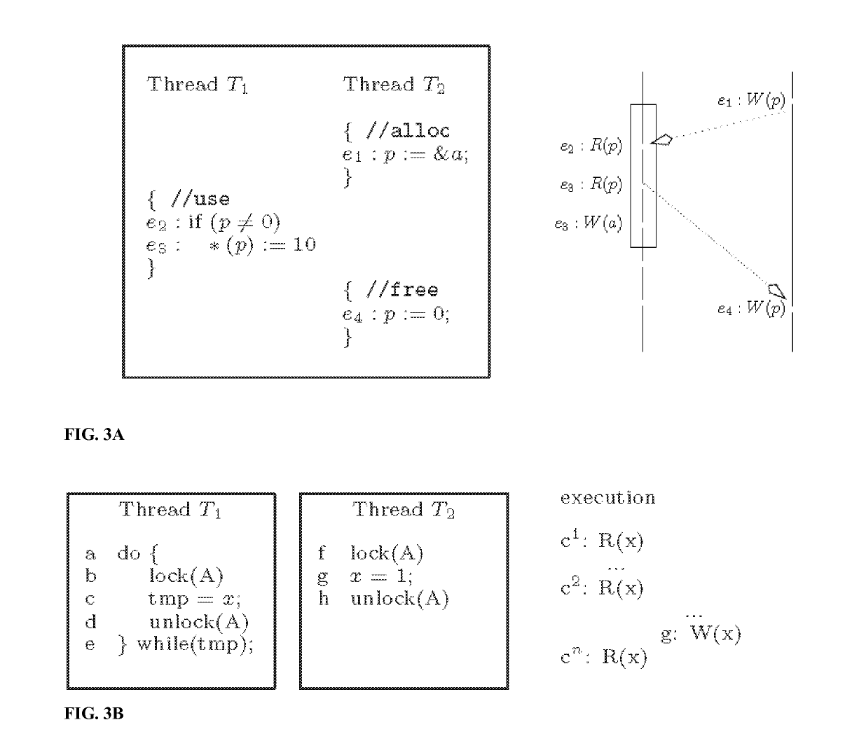

Consider the example of FIG. 3A, which has two threads T₁,T₂ sharing the pointer p. Assume that p=0 initially. In the given execution, p is first initialized in e₁, then used in e₂,e₃, and finally freed in e₄. (Assume e₁-e₄ are statements in the form (file,line,thr,ctx).) Since e₁ is the last statement before e₂ and they have a data conflict, the system adds e₁ to HaPSet[e₂]. For e₃ the system does not add any statement into HaPSet[e₃] because e₂ is the last statement accessing p but it is from the same thread (hence no conflict). e₃ is added to HaPSet[e₄] since e₃ precedes e₄ in the given execution, and they have a data conflict. To sum up, the HaPSets learned from this execution are as follows,

HaPSet[e₁]={ }, HaPSet[e₂]={e₁},

HaPSet[e₃]={ }, HaPSet[e₄]={e₃}.

Consider FIG. 3A again, where the block containing e₂, e₃ is meant to be executed atomically—it first confirms that pointer p is not null and then stores 10 to the pointed memory location. Therefore, whether e₂ and e₃ are two consecutive reads of an interleaving is key to deciding whether the interleaving is buggy. HaPSets can capture this atomicity constraint: in all good runs where atomicity is not violated, HaPSet[e₃] is always empty. This is because, although e₁,e₄ can be executed either before e₂ or after e₃, event e₃ is always preceded by e₂. Therefore, neither e₁ nor e₄ can appear in HaPSet[e₃]. Second, e₂∉HaPSet[e₄] because e₃ (instead of e₂) always precedes e₄. Therefore the HaPSets leaned from all the good runs are as follows,
HaPSet[e₁]={e₂}, HaPSet[e₂]={e₁, e₄},
HaPSet[e₃]={ }, HaPSet[e₄]={e₃}.
   During testing, it is more fruitful to test interleavings that have not been covered by the above HaPSets. One such interleaving is ρ′=e₁e₂e₄e₃, which violates the atomicity and leads to the deference of a null pointer. In this example, p′ corresponds to HaPSet[e₃]={e₄} and HaPSet[e₄]={e₂}.

HaPSets can be used to avoid the excessive testing of certain interleavings that do not offer any new concurrency scenario. Consider FIG. 3B as an example, there are two threads T₁,T₂ communicating via variable x. Assume that x=0 initially. In the given execution {abcde}^{k} fghabcde, the loop in T₁ is executed k times before g in thread T₂ is executed.

Without using HaPSets, systematic testing would have to test a potentially large set of interleavings, each with a different number of loop iterations. This is because, strictly speaking, none of these interleavings are equivalent to others; therefore, based on the theory of partial order reduction, one needs to test all of them. However, such tests are often wasteful since they rarely lead to additional bugs. The HaPSets computed on these interleavings are
HaPSet[g]={c}, HaPSet[c]={g},
HaPSet[b]={f}, HaPSet[f]={b}.
   This is because some instances of statement c (or f) are immediately dependent on instances of g (or b), and vice versa. (Except for recursive locks, unlock statements are ignored when computing HaPSets.) When using HaPSets as guidance, the system can avoid the aforementioned excessive backtracking because none of these interleavings can offer a concurrency scenario that has not been covered by the HaPSets.

For the guided search to be effective, the system learns HaPSets from a diversified set of interleavings. The quality of the learned HaPSets will be affected by both the test cases and the thread schedules. Randomized delay can be added to the scheduler to diversify the thread interleavings. In one testing environment, the program is executed under the control of a scheduler process, which is capable of controlling the order of operations from different threads. These control points are inserted into the program source code automatically via an instrumentation phase, before the source code is compiled into an executable. For HaPSet learning, the system maintains the following data structures: a set HaPSet[st] for each statement st∈Stmt; and a search stack S of abstract states s₀ . . . sₙ, where s₀ is the initial state and sₙ is the final state of the interleaving. Recall that each s∈S is an abstract state because s does not store the actual valuations of program variables. Let sᵢ.sel be the event executed at sᵢ in the given interleaving in order to reach sᵢ₊₁.

The pseudo code of the HaPSet learning is presented in the pseudo code called Algorithm 1.

Algorithm 1 Learning from good test runs

| | |
|---|---|
| 1: | Initially: For all statements st, HaPSet[st] is empty; |
| 2: | S is an empty stack; RANDCTEST(s₀) |
| 3: | RANDCTEST(s) { |
| 4: | S.push(s); |
| 5: | LEARNHAPSETS(s); // learning HaPSets |
| 6: | while (s.enabled is not empty) { |
| 7: | Let e be a randomly chosen item from s.enabled; |
| 8: | //Delay thread tid(e) for a random period; |
| 9: | Let s.sel = e; |
| 10: | $Let {s}^{′} be the new state after executing s {\to }^{e} {s}^{′} ;$ |
| 11: | RANDCTEST(s′); |
| 12: | } |
| 13: | S.pop(s); |
| 14: | } |
| 15: | LEARNHAPSETS(s) { |
| 16: | if (s ≠ s₀) ){ |
| 17: | Let sₚ ∈ S be the state preceding s; |
| 18: | Traverse stack S, for each thread, find the last state |
| | s_{d}. where s_{d}.sel and sₚ.sel access the same object; |
| 19: | if (s_{d}.sel and sₚ.sel have a data conflict) { |
| 20: | Let stₚ = stmt(sₚ.sel); |
| 21: | Let st_{d} = stmt(s_{d}.sel); |
| 22: | HaPSet[stₚ] ← HaPSet[stₚ] ∪ {st_{d}} |
| 23: | } |
| 24: | } |
| 25: | } |

The procedure RANDCTEST takes the initial state s₀ as input and generates the first interleaving with a randomized thread schedule. Each state s∈S is associated with a set s.enabled of events. Recall, for example, that a lock acquire would be considered as disabled at if the lock is held by another thread. Similarly, a wait would be considered as disabled at s, if the notification has not been sent. At each execution step, we randomly pick an event e∈s.enabled, execute it from s, which leads to state s′.

Note that the thread schedules ultimately are still determined by the underlying operating system. This ensures that all the generated interleavings are real. If any of them can trigger a program failure, then it is a real bug. Otherwise, all of them are assumed to be good runs, in that they expose the desired program behavior.

During each run, learnHaPSets is invoked at every execution step. The input to this procedure is the newly reached state s. Let sₚ be the state prior to reaching the current state s, and sₚ.sel be the event executed between sₚ and s. For each thread, the last executed event s_{d}.sel is found such that (1) s_{d}.sel and sₚ.sel access the same object, (2) they are executed by different threads, and (3) there is a data conflict (read-write, write-write, lock-lock, or wait-notify). If such an s_{d}.sel exists, the system adds the statement stmt(s_{d}.sel) into the HaPSet of stmt(sₚ.sel). Systematically testing all possible interleavings can be achieved using stateless model checking. It can be viewed as a natural extension of randCTest in Algorithm 1. However the scheduler here has total control in deciding the thread schedule.

The overall algorithm is illustrated in Algorithm 2 by procedure SYSCTEST. It checks all possible thread schedules of the program for a given test input.

Algorithm 2 Systematic concurrency testing framework

| | |
|---|---|
| 1: | Initially: S is an empty stack; SYSCTEST(s₀) |
| 2: | SYSCTEST(s) { |
| 3: | S.push(s); |
| 4: | UPDATEBACKTRACK(s); |
| 5: | let τ ∈ Tid such that ∃t ∈ s.enabled: tid(t) = τ; |
| 6: | s.backtrack ← {τ}; |
| 7: | s.done ← Ø; |
| 8: | while (∃t: tid(t) ∈ s.backtrack and t ∉ s.done) { |
| 9: | s.done ← s.done ∪ {t}; |
| 10: | let s.sel = t; |
| 11: | $let {s}^{′} be the new state after executing s {\to }^{t} {s}^{′} ;$ |
| 12: | SYSCTEST(s′); |
| 13: | } |
| 14: | S.pop(); |
| 15: | } |
| 16: | UPDATEBACKTRACK(s) { |
| 17: | for each t ∈ s.enabled { |
| 18: | let s_{d} ∈ S and s_{d}.sel be the latest event such that |
| | s_{d}.sel is dependent and may be co-enabled with t, |
| 19: | if (such s_{d} exists){ |
| 20: | s_{d}.backtrack ← s_{d}.backtrack∪ BTSET(s_{d}, t) |
| 21: | } |
| 22: | } |
| 23: | } |

In addition to s.enabled, each s has an associated subset s.done [symbol] s.enabled of events, recording the scheduling choices made at s in some previous test runs. Furthermore, each s has an associated set s.backtrack consisting of a subset of the enabled threads at s. Each τ∈s.backtrack represents a future scheduling choice at s, i.e. thread τ will be executed at s in some future test run.

The procedure SYSCTEST takes state s as input, where s₀ is used for the initial call. At each step, it first invokes subroutine updateBacktrack to update backtracking points at some previous state s′∈S. (Backtracking will be explained in the next paragraph.) Then from s.backtrack it picks an enabled thread τ to execute, leading to a distinct thread interleaving. The recursive call at Line 11 returns only after the interleaving ends and the system backtracks to state s. At this point, s.backtrack must have been updated by some previous call to sysCTest; it may contain some threads other than τ, meaning that executing them (as opposed to τ) from state s may lead to different interleavings. The entire procedure terminates when we backtrack from state s₀ eventually. Since the system does not store the concrete program states in S, backtracking to a state s′ is implemented by re-starting the test run and then applying the same thread schedule till state s′ is reached again.

In the naive approach, at every state s∈S, s.backtrack consists of all the enabled threads. The set of interleavings generated by this naive algorithm is the same as the set of possible interleavings generated by the actual program execution. However, the naive approach may end up testing many redundant interleavings. updateBacktrack (s) is designed to remove some of the redundant interleavings. It takes the current state as input and iterates through all the enabled event t∈s.enabled to find the latest event s_{d}.sel that is dependent and may be co-enabled with t. If such an s_{d} exists, it means that if the execution order is flipped from s_{d}.sel . . . t to t . . . s_{d}.sel, the new interleaving will not be equivalent to the current one. In practice, the various systematic concurrency testing tools differ mainly in their ways of computing the backtrack set.

The baseline algorithm is only slightly different from the naive algorithm. That is,

BTSet←{tid(q)|q∈s_{d}.enabled}

It is still more efficient than the naive algorithm, since it adds BTSet only at state s_{d} (as opposed to every state). For example, consider the case where s_{d} does not exist in Line 18. In this case, t is independent with all the previously executed events (s_{d}.sel for all s_{d}∈S), and swapping the execution order of t and s_{d}.sel would not lead to a new equivalence class. The baseline algorithm would not add any backtrack point for such cases.

Traditionally, a context switch is defined as the computing process of storing and restoring the CPU state (context) when executing a concurrent program, such that multiple threads can share the same CPU resource. The idea of using context bounding to reduce complexity of software verification was first introduced for static analysis and later for testing. It has since become an influential techniques since in practice many concurrency bugs can be exposed by interleavings with few context switches. In this setting,

BTSet←{tid(q)|q∈s_{d}.enabled, and cb(s_{d},q)≦mcb}

where cb(s_{d},q) is the number of context switches after executing q at s_{d}, and mcb is the maximal number of context switches allowed. From state s_{d}, one can execute q only if the number of context switches will not exceed the bound. Although PCB can skip many interleavings, for the ones with ≦mcb context switches, we still need exhaustive search. For large programs, even with small bound (e.g. 4 or 5), the number of interleavings is still extremely large.

Partial order reduction is based grouping interleavings into equivalence classes and then testing only one representative from each equivalence class. It is a well studied topic in model checking. For concurrency testing, the most advanced technique is the DPOR algorithm by Flanagan and Godefroid. BTSet is computed by Algorithm 3. First, the process searches for an event q∈s_{d}.enabled such that there exists a happens-before relation between q and the currently enabled event t. Intuitively, q happens before t in an interleaving if either (a) the system cannot execute t before q due to program semantics, or (b) swapping the execution order of q and t would lead to a different equivalence class. Obviously q happens before t if they are from the same thread. Other examples include (1) q and t are from different threads but have data conflict over a shared object; and (2) there exist events r,s in the interleaving such that, q happens before r, r happens before s, and s happens before t. If such q exists, then a reduction situation exists—the system only needs to add tid(q) to s_{d}.backtrack, since executing thread tid(q) is necessary for the purpose of swapping t and s_{d}.sel. (In POR theory, this backtrack set is called a persistent set.) Otherwise, there is no reduction and the system resorts to the baseline to add all enabled threads to s_{d}.backtrack. Although partial order reduction is sound in that it never misses real bugs, in practice, the number of interleavings after DPOR can still be very large.

Algorithm 3 Computing the backtrack set in DPOR.

1: let q ε s_{d}.enabled such that either tid(q) = tid(t), or
there is a happens-before relation between q and t }
2: if (such q exists)
3: BTSET ← {tid(q)};
4: else
5: BTSET ← {tid(q) | q ε s_{d}.enabled};

Next, systematic testing guidance is discussed. In contrast to the exhaustive search in DPOR and PCB, the system uses HaPSets learned from the already tested (good) runs to the selection of the next interleaving. HaPSets are used to select interleavings, and then used to continuously update the HaPSets. This is done by modifying the implementation of subroutine updateBacktrack. In Algorithm 2, Line 18 of updateBacktrack searches through the stack S to find the last event s_{d}.sel that is dependent and may be co-enabled with t. If such an s_{d}.sel exists, it means that swapping the execution order from s_{d}.sel . . . t to t . . . s_{d}.sel would produce a different interleaving. In the modified version, in addition to the condition in Line 18, the following HaPSet related condition must hold: stmt(t)∉HaPSet[stmt(s_{d}.sel)].

If stmt(t) is not in the HaPSet of stmt(s_{d}.sel), it means that in all tested runs, the statement that generates s_{d}.sel has never been immediately dependent upon the statement that generates t. In this case, the new execution order t . . . s_{d}.sel represents a concurrency scenario that has never been covered by the previous test runs. On the other hand, if stmt(t) is already in the HaPSet of stmt(s_{d}.sel), the new interleaving would have a lower risk because this concurrency scenario has been covered previously.

Algorithm 4 illustrates the new procedure UpdateBacktrack for HaPSet guided selective search. One of the main advantages of the HaPSet guided search is that, it fits naturally into the existing flow of systematic testing. The addition of HaPSet guided search requires only small changes to the software architecture. The guidance from HaPSets affect only our selection of state s_{d} (Line 4). Once s_{d} is selected, the backtrack set can be computed independently. This means we can choose to use the various existing methods to compute BTSet. In practice, we have found that both PCB and DPOR work well under the guidance of HaPSets, although combining HaPSet with DPOR often performs slightly better. Note that HaPSet guidance effectively prunes away large subspaces in the search. Unlike DPOR, this pruning is not safe, i.e. it may miss errors. This is the basic tradeoff we make to gain scalability and performance.

Algorithm 4 Guiding the systematic testing (with DPOR)

```
1:  UPDATEBACKTRACK(s) {
2:  for each t ε s.enabled {
3:  let s_{d} ε S and s_{d}.sel be the latest event such that
        (1) S_{d}.sel is dependent and may be co-enabled with
    t,
        (2) stmt(t) ∉ HaPSet[stmt(s_{d}.sel)];  // guiding
4:  if (such s_{d} exists){
5:  s_{d}.backtrack ← s_{d}.backtrack∪ BTSET(s_{d},t)
6:  }
7:  }
8:  }
```

In the guided search framework, the quality of HaPSets is very important. Although the system can diversify thread schedules via randomization, the training runs may still miss many concurrency scenarios. The interleaving encountered during the guided search may contain these missing concurrency scenarios, and therefore are complementary to the initial learning. Therefore, the system updates the initial HaPSets during systematic testing by continuously learning from the tested (good) interleavings. Continuous learning is made possible by the fact that, unless a bug is detected, the interleaving checked by systematic testing is always a good run.

Algorithm 5 illustrates the overall selective search algorithm, wherein the call to learnHaPSets at Line 4 allows for continuous learning of HaPSets. The learning subroutine is the same as the one used in Algorithm 1.

Algorithm 5 Continuous learning within systematic testing

| | |
|---|---|
| 1: | Initially: S is an empty stack; GUIDEDCTEST(s₀) |
| 2: | GUIDEDCTEST(s) { |
| 3: | S.push(s); |
| 4: | LEARNHAPSETS(s); // continuous learning |
| 5: | UPDATEBACKTRACK(s); |
| 6: | let τ ∈ Tid such that ∃t ∈ s.enabled: tid(t) = τ; |
| 7: | s.backtrack ← {τ}; |
| 8: | s.done ← Ø; |
| 9: | while (∃t: tid(t) ∈ s.backtrack and t ∉ s.done) { |
| 10: | s.done ← s.done ∪ {t}; |
| 11: | $let {s}^{′} be the new state after executing s {\to }^{t} {s}^{′} ;$ |
| 12: | GUIDEDCTEST(s′); |
| 13: | } |
| 14: | S.pop(); |
| 15: | } |

In continuous learning, the good interleavings produced by systematic testing are freely available, since they are byproducts of the search. The more concurrency scenarios we capture using the HaPSets, the less number of interleavings would need to be tested in the future. This ensures progress with respect to the HaPSet coverage metric. Therefore, on-the-fly updating HaPSets allows the guided search to become a self-improving process, making the whole process converge much faster.

### Example

Consider FIG. 3B again. Assume that the first interleaving is

$${ρ}_{1} = {s}_{0} {->}^{a} {s}_{1} {->}^{f } {s}_{2} {->}^{g} … {s}_{5} {->}^{b} {s}_{6} {->}^{c} …$$

The HaPSets computed from ρ₁ via continuous learning are HaPSet[c]={g}, HaPSet[b]={f}. Furthermore, the DPOR backtrack sets will be s₁.backtrack={1,2} and s₂.backtrack={2}, since thread 1 is disabled at state s₂. According to the guided search algorithm, the next interleaving to be executed is

$${ρ}_{2} = {s}_{0} {->}^{a} {s}_{1} {->}^{b} …$$

The new HaPSets computed from ρ₂ are HaPSet[g]={c}, HaPSet[f]={b}. After that, however, the guided search algorithm will allow no other interleavings.

A key point illustrated by the above example is that pruning actually happens at states like s₁ where locking statements are executed, not when memory-accessing statements (c,g) are executed. This is why synchronizations are needed in the definition of HaPSet. In fact, if only memory-accessing statements (as in the definition of PSet) are used, there will be no pruning possible for FIG. 3B.

In sum, the system described above provides a coverage-guided systematic testing framework, where dynamically learned ordering constraints over shared object accesses are used to select only high-risk interleavings for test execution. An interleaving is of high-risk if it has not been covered by the ordering constraints, meaning that it has concurrency scenarios that have not been tested. The method consists of two components. First, the system utilizes dynamic information collected from good test runs to learn ordering constraints over the memory-accessing and synchronization statements. These ordering constraints are treated as likely invariants since they are respected by all the tested runs. Second, during the process of systematic testing, the system uses the learned ordering constraints to guide the selection of interleavings for future test execution. Experiments on public domain multithreaded C/C++ programs show that, by focusing on only the high-risk interleavings rather than enumerating all possible interleavings, our method can increase the coverage of important concurrency scenarios with a reasonable cost and detect most of the concurrency bugs in practice. HaPSets can be used to capture these ordering constraints and use them as a metric to cover important concurrency scenarios. This selective search strategy, in comparison to exhaustively testing all possible interleavings, can significantly increase the coverage of important concurrency scenarios with a reasonable cost, while maintaining the capability of detecting subtle bugs manifested only by rare interleavings.

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

By way of example, a block diagram of a computer to support the system is discussed next. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A method for coverage-guided systematic concurrency testing of software for concurrency bugs, comprising:
determining one or more HaPSet (History-aware Predecessor Set) ordering constraints over shared object accesses;
applying the HaPSet ordering constraints to select high-risk interleavings; and
executing the high-risk interleavings to detect concurrency bugs.

2. The method of claim 1, comprising determining an interleaving as high-risk if the interleaving has not been covered by the HaPSet ordering constraints.

3. The method of claim 1, comprising determining the HaPSet ordering constraints by dynamically learning them from training test runs.

4. The method of claim 3, where the dynamic learning comprises collecting HaPSet information from good test runs, and ordering constraints over one or more memory-accessing and synchronization statements.

5. The method of claim 1, wherein during systematic concurrency testing, comprising performing stateless model checking to generate the set of interleavings, and applying HaPSet ordering constraints to select interleavings among these set of interleavings.

6. The method of claim 3, comprising using randomized training test runs to determine the HaPSets.

7. The method of claim 3, comprising using form standard stress testing to determine the HaPSets.

8. The method of claim 1, wherein HaPSet ordering constraints are continuously updated using the already tested interleavings during systematic concurrency testing and HaPSet ordering constraints are used to select future interleavings.

9. The method of claim 1, wherein HaPSets are applied to all possible interleavings during systematic concurrency testing.

10. The method of claim 1, wherein HaPSets are applied to a subset of all possible interleavings.

11. The method of claim 10, wherein HaPSets are applied to a subset of interleavings chosen by dynamic partial order reduction.

12. The method of claim 10, wherein HaPSets are applied to a subset of interleavings chosen by preemptive context bounding.

13. A system for coverage-guided systematic concurrency testing of software for concurrency bugs, comprising:
means for determining one or more HaPSet (History-aware Predecessor Set) ordering constraints over shared object accesses;
means for applying the HaPSet ordering constraints to select high-risk interleavings; and
means for executing the high-risk interleavings to detect concurrency bugs.

14. The system of claim 13, wherein an interleaving is considered as high-risk if the interleaving has not been covered by the HaPSet ordering constraints.

15. The system of claim 13, wherein the HaPSet ordering constraints are determined by dynamically learning them from training test runs.

16. The system of claim 15, where the dynamic learning comprises collecting HaPSet information from good test runs, consisting of ordering constraints over the memory-accessing and synchronization statements.

17. The system of claim 15, wherein during systematic concurrency testing, stateless model checking is used to generate the set of interleavings, and HaPSet ordering constraints are applied to select interleavings among these set of interleavings.

18. The system of claim 15, comprising using randomized training test runs or form standard stress testing to determine the HaPSets.

19. The system of claim 13, wherein HaPSet ordering constraints are continuously updated using the already tested interleavings during systematic concurrency testing and HaPSet ordering constraints are used to select future interleavings.

20. The system of claim 13, wherein HaPSets are applied to all possible interleavings during systematic concurrency testing, to a subset of all possible interleavings, or to a subset of interleavings chosen by dynamic partial order reduction.

21. The system of claim 10, wherein HaPSets are applied to a subset of interleavings chosen by preemptive context bounding.
